(19) United States
(12) Patent Application Publication
(10) Pub. No.: US 2011/0099717 A1
(43) Pub. Date: May 5, 2011

(54) MEDICAL LITTER

(76) Inventor: Bernard T. Windauer, Kalispell, MT (US)

(21) Appl. No.: 12/833,969

(22) Filed: Jul. 10, 2010

Related U.S. Application Data
(60) Provisional application No. 61/257,400, filed on Nov. 2, 2009.
(60) Provisional application No. 61/259,719, filed on Nov. 10, 2009.

(51) Int. Cl. A61G 1/013; A61G 1/02

(52) U.S. Cl. 5/627

(57) ABSTRACT

An apparatus comprises a frame assembly comprising a first side member and a second side member, and at least one spreader member. The spreader member comprises a first triangular member, a coupling member and a second triangular member. The first and second triangular members each comprise a vertex end and a base end. The coupling member comprises first and second end portions. The first triangle member is coupled to the first side member along the base end of the first triangular member. The second triangle member is coupled to the second side member along the base end of the second triangular member. The vertex end of the first triangular member and the vertex end of the second triangular member are respectively coupled to the first and second end portions of the coupling member.

### CROSS-REFERENCE TO RELATED PATENT APPLICATIONS

The present invention claims the benefit of priority of U.S. Provisional Patent Application Ser. No. 61/257,400 filed on Nov. 2, 2009, entitled “Medical Litter,” and invented by Bernard T. Windauer, and U.S. Provisional Patent Application Ser. No. 61/259, 719, filed Nov. 10, 2009, entitled “Medical Litter,” and invented by Bernard T. Windauer, the disclosures of both being incorporated herein by reference.

### BACKGROUND

The subject matter disclosed herein relates generally to litter systems and devices for use in carrying patients or casualties, and, in particular, the subject matter disclosed herein relates to a collapsible litter device that employs a detachable fabric bed.

In both the medical and military fields, there is a need for ways to immobilize and transport patients and casualties. For example, in modern rescue operations, those tasked with rescuing are frequently required to move patients up and down stairs or over uneven terrain for long distances, and under extreme environmental conditions.

Numerous stretchers or litters have been proposed and made available for this purpose. Of the many different types of litters, collapsible litters are of particular interest based on their convenience and utility. The ability to collapse and fold litters into a compact package is advantageous for storing, handling and transporting litters that are not in use. Even more important than providing an easily collapsible litter, however, is to provide a litter that is sufficiently rigid and strong for all purposes. Accordingly, collapsible litters should not only be compact and lightweight for transporting purposes, but they must also be rigid and sturdy in the extended position.

While various designs for collapsible litters or carriers presently exist, each of these prior designs is problematic. Traditional, collapsible litters tend to be cumbersome and difficult to maneuver. These litters do not allow for the movement necessary to transport a patient up and down a narrow stairway containing curves and changes of direction. Many traditional litters require the attachment specialty devices to facilitate mobility and attachment during transport of the patient via air or ground ambulance.

Some litters are easily collapsed, but experience mechanical or structural problems when extended into a rigid structure for carrying a patient. Many collapsible litters fail to remain locked in an open or extended position. Other collapsible litters are simply too cumbersome and difficult to open for patient transport or re-pack for transport. Still others are constructed from materials that are too fragile or brittle for extreme environmental conditions. The weight of most litter designs is also a problem, especially in situations in which the litters must be transported in a backpack over long distances and/or in extreme weather conditions.

Additional complications can occur if the patient or casualty has to be efficiently thermally insulated and/or immobilized. Furthermore, many of the existing stretcher designs are uncomfortable to the patient. There are also additional medical risks for the patient if moved multiple times from the initial location of the injury. Most litters are generally useful only for moving a patient from one location to another.

Litter systems presently in use have also exhibited problems when a patient or casualty is being transported from a place of contamination. These litters are not easily cleaned, and typically require that the patient or casualty be removed from the litter and that the litter be discarded. The reason for discarding the complete litter is that the fabric bed is semi- or permanently affixed to the litter frame.

Accordingly, there exists a need for a litter that is effective in any and all medical and military situations. The subject matter disclosed herein addresses this need through a collapsible litter that is compact, lightweight, and yet rigid and sturdy in the extended position. Furthermore, the litter of the subject matter disclosed herein can be folded and unfolded with the utmost of ease under the most adverse conditions.

### BRIEF DESCRIPTION OF THE DRAWINGS

The subject matter disclosed herein is illustrated by way of example and not by limitation in the accompanying figures in which like reference numerals indicate similar elements and in which:

FIGS. 1A and 1B depict perspective views of a collapsible litter system and apparatus according to an exemplary embodiment of the subject matter disclosed herein;

FIGS. 2A and 2B depict perspective views of a fabric bed portion of a collapsible litter system and apparatus according to an exemplary embodiment of the subject matter disclosed herein;

FIG. 3A depicts a perspective view of a frame assembly of a collapsible litter system and apparatus comprising triangular truss spreader members according to an exemplary embodiment of the subject matter disclosed herein;

FIG. 3B depicts a perspective view of a frame assembly of a collapsible litter system and apparatus comprising conventional spreader members according to an exemplary embodiment of the subject matter disclosed herein;

FIG. 4 depicts a perspective view of a frame assembly of a collapsible litter system and apparatus comprising triangular truss spreader member according to an exemplary embodiment of the subject matter disclosed herein;

FIG. 5 depicts a perspective view of a frame assembly of a collapsible litter system and apparatus in the first stage of folding subsequent to unlocking the spreader member central lock plates according to an exemplary embodiment of the subject matter disclosed herein;

FIG. 6 depicts a perspective view of a frame assembly of a collapsible litter system and apparatus in the second stage of folding subsequent to folding the spreader member to the same plane as the side members according to an exemplary embodiment of the subject matter disclosed herein;

FIG. 7 depicts a perspective view of a frame assembly of a collapsible litter system and apparatus in the third stage of folding wherein the side members are hinged at each end according to an exemplary embodiment of the subject matter disclosed herein;

FIG. 8 depicts a perspective view of a frame assembly of a collapsible litter system and apparatus in the fourth stage of folding wherein the side members are hinged to a parallel orientation with one another according to an exemplary embodiment of the subject matter disclosed herein;

FIG. 9 depicts a side perspective view of a handle portion of a collapsible litter system and apparatus in a locked position according to an exemplary embodiment of the subject matter disclosed herein;

FIG. 10 depicts a side perspective view of a handle portion of a collapsible litter system and apparatus in an unlocked position according to an exemplary embodiment of the subject matter disclosed herein;

FIG. 11 depicts a side perspective view of a handle portion of a collapsible litter system and apparatus in an unlocked and partially rotated position according to an exemplary embodiment of the subject matter disclosed herein;

FIG. 12 depicts a side perspective view of a handle portion of a collapsible litter system and apparatus in a 90-degree rotated and locked position according to an exemplary embodiment of the subject matter disclosed herein;

FIG. 13 depicts a perspective view of a triangular truss shaped spreader member of a collapsible litter system and apparatus in the folded and locked position (reference FIG. 5) according to an exemplary embodiment of the subject matter disclosed herein;

FIG. 14 depicts a perspective view of a spreader member of a collapsible litter system and apparatus wherein the triangular truss shaped spreader is rotated into the same plane as the first and second side members (reference FIG. 6) according to an exemplary embodiment of the subject matter disclosed herein;

FIG. 15 depicts a perspective view of a triangular truss shaped spreader member of a collapsible litter system and apparatus wherein one side of the triangular truss shaped spreader member assembly is in an unfolded and locked position according to an exemplary embodiment of the subject matter disclosed herein;

FIG. 16 depicts a perspective view of a triangular truss shaped spreader member of a collapsible litter system and apparatus with a single button unlocking mechanism according to an exemplary embodiment of the subject matter disclosed herein;

FIG. 17 depicts a top perspective view of one exemplary embodiment of a lockable spreader assembly (shown with one cover plate (opposite side) removed for clarity) according to the subject matter disclosed herein; and

FIG. 18 depicts a front view of the exemplary embodiment of lockable spreader assembly depicted in FIG. 19 with a cover plate removed for clarity.

### DETAILED DESCRIPTION

As used herein, the word “exemplary” means “serving as an example, instance, or illustration.” Any embodiment described herein as “exemplary” is not to be construed as necessarily preferred or advantageous over other embodiments.

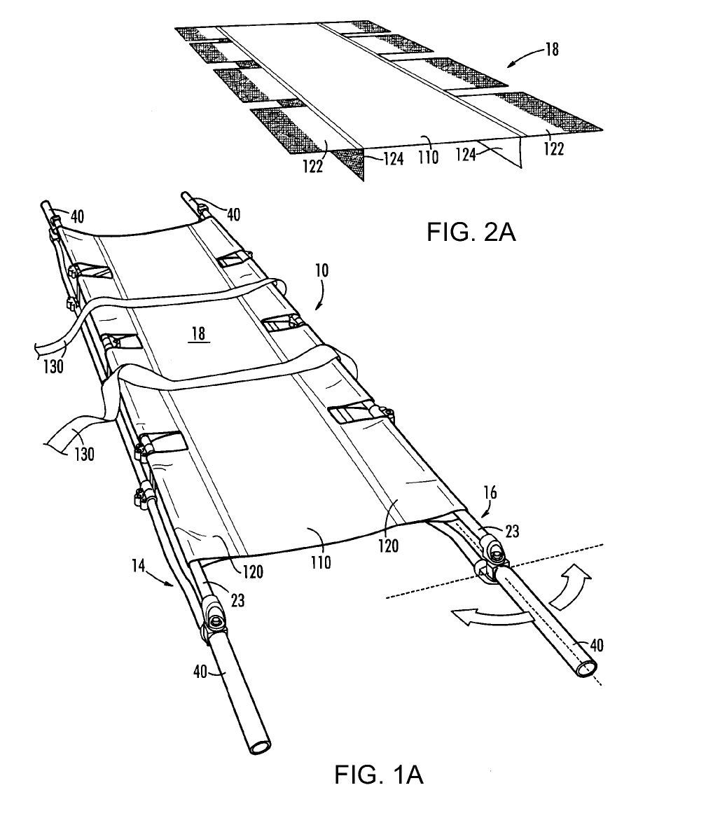

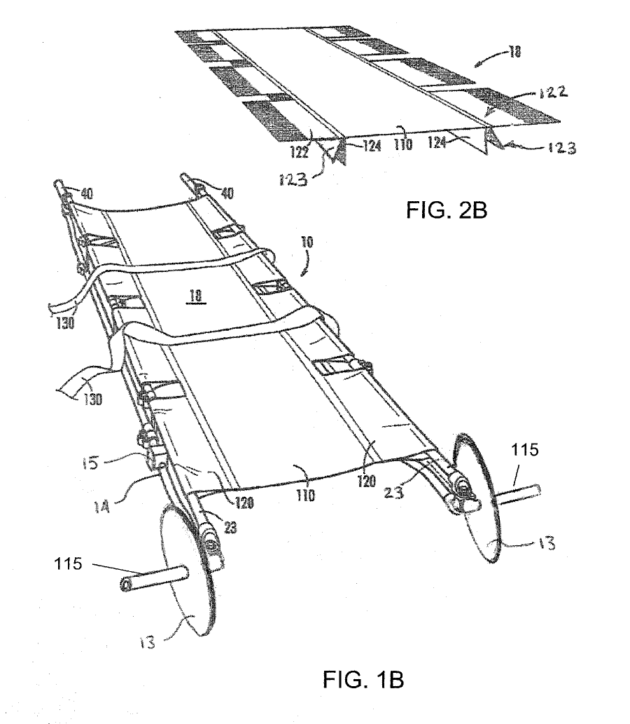

The subject matter disclosed herein comprises a collapsible litter system and apparatus, and method for folding and unfolding the collapsible litter. As depicted in FIGS. 1-3B, a litter, or litter system, 10 comprises a frame assembly 12 having a first side member 14 and a second side member 16 that are interconnected by one or more spreader members 20 for maintaining side members 14, 16 in a laterally spaced arrangement when litter 10 is an unfolded, or extended, position. Litter 10 further comprises a fabric bed 18 that is releasably attached to frame assembly 12, and a plurality of handles 40 that can be folded in numerous directions for convenient use, storage and/or collapsing of litter 10.

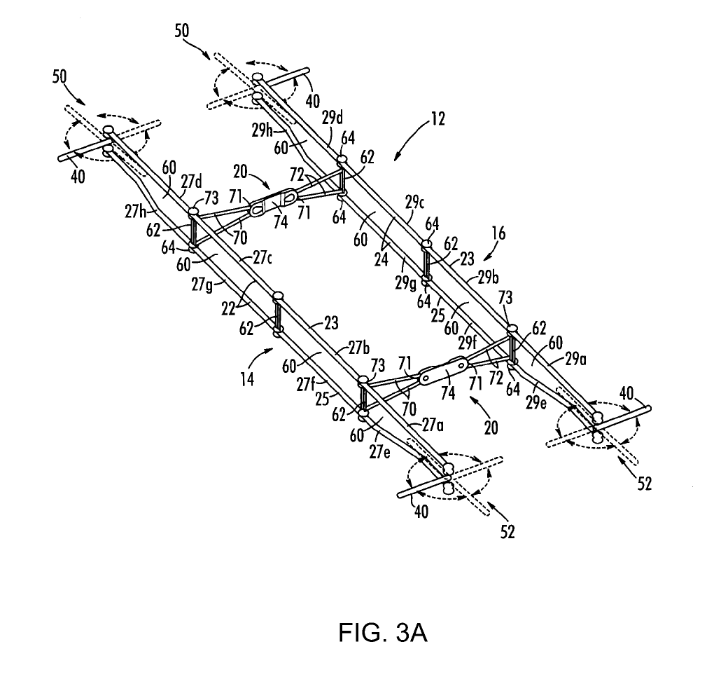

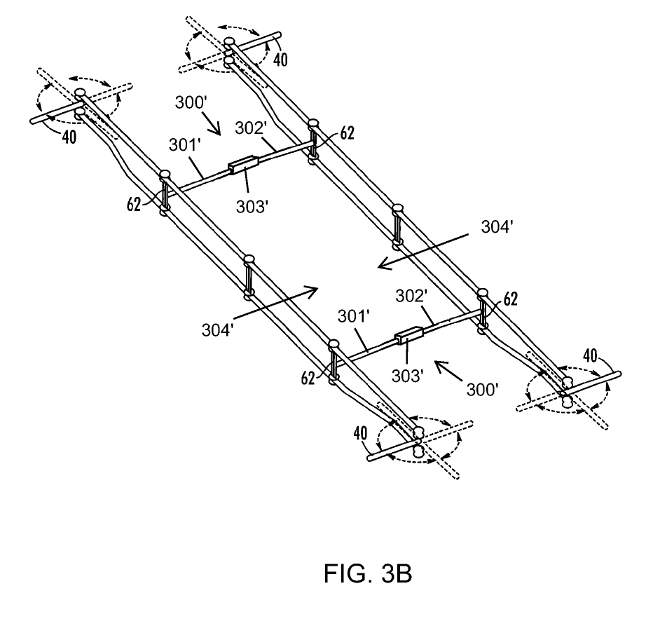

When frame assembly 12 (FIG. 3A) is an unfolded, or extended, position, side members 14 and 16 extend in a longitudinal direction and at least two spreader members 20 extend in a transverse direction that is substantially perpendicular to parallel side members 14 and 16. The first and second side member assemblies 14, 16 are each comprised of four subassemblies 60. Each subassembly 60 is comprised of a pair of respectively spaced apart and substantially parallel beams or poles 22, 24 that extend longitudinally and are connected at the ends by hinge blocks 62 to form the side members of unfolded litter 10. In an extended position, the parallel poles 23 and 25 of each pair of subassemblies 60 are arranged in a vertical, or upright position, so that one pole 23 of each pair is positioned on top of or over the second corresponding pole 25 from each pair.

In an exemplary embodiment, each of the frame side member subassemblies 60 (FIG. 3A) comprises a pair of pole arms 23, 25 (FIG. 3A) and hinge blocks 62 that are pivotally connected for moving between a folded configuration, such that the side member subassemblies 60 are generally stacked one upon the other, and an unfolded, or extended, configuration, such that the side member subassemblies 60 are generally aligned end-to-end in a common or parallel plane to form each of the side member assemblies 14, 16.

In one exemplary embodiment, the top pole of a first pair of poles 22 comprises a plurality of pole arms 27a-27d that are pivotally connected and coupled to frame assembly 12. The bottom pole of the first pair of poles 22 similarly comprises a plurality of pole arms 27e-27h that are pivotally connected and coupled to frame assembly 12. In the same way, the top pole of a second pair of poles 24 comprises a plurality of pole arms 29a-29d that are pivotally connected and coupled to frame assembly 12. The bottom pole of the second pair of poles 24 similarly comprises a plurality of pole arms 29e-29h that are pivotally connected and coupled to frame assembly 12.

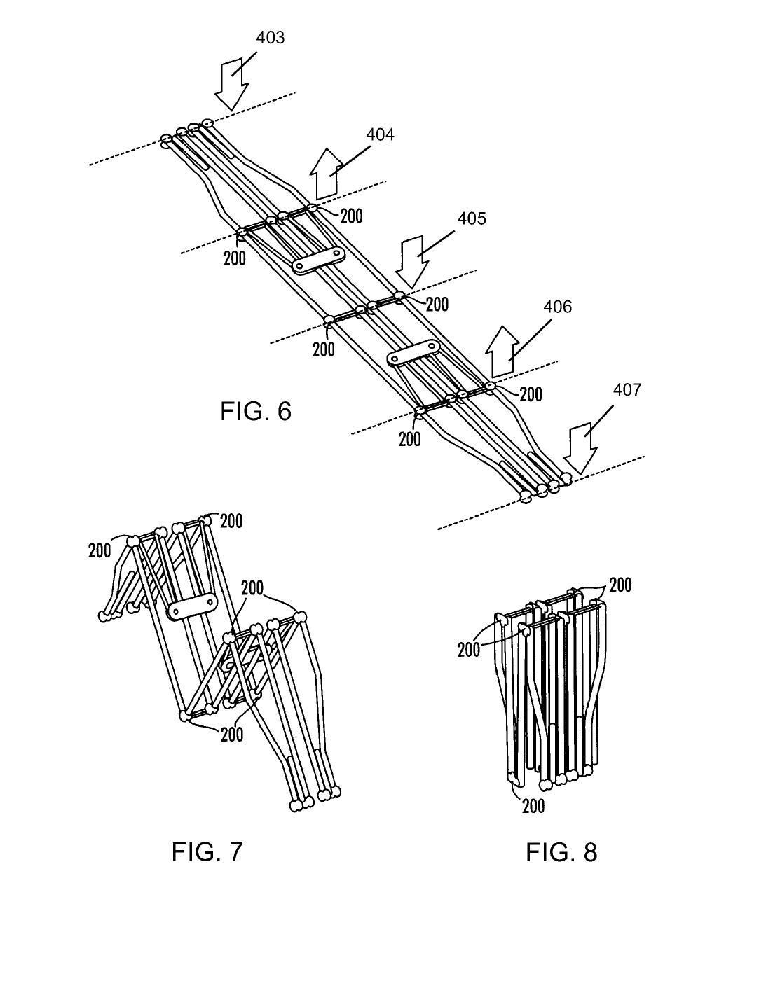

A plurality of spaced apart cross beams 62 are positioned between each pair of poles 22, 24. Cross beams 62 are rigidly connected to and span between the poles that form the pairs of poles 22, 24. In particular, cross beams 62 extend substantially perpendicularly from a bottom pole 25 to a top pole 27 of each pair of poles 22, 24. Cross beams 62 are respectively located at juncture points 64 between the plurality of pole arms 27a-27d, 27e-27h, 29a-29d, and 29e-29h. For pivoting purposes, each juncture point 64 comprises one or more hinges 200 (FIGS. 6-8) that are coupled to frame assembly 12.

In one exemplary embodiment, the substantially parallel poles 22, 24 (FIG. 3A) of side members 14, 16 comprise curved members so that the poles converge at opposing, outermost ends 50 and 52, of the side members. For example, as depicted in FIGS. 3A and 3B, bottom poles 25 of each pair of poles 22, 24 can be curved at each of its opposing ends 50, 52 so that a curved pole 25 approaches a convergence point with the corresponding substantially straight pole 23. In particular, pole arms 27e, 27h, 29e, and 29h, can each be curved and positioned to respectively approach a convergence point with corresponding pole arms 27a, 27d, 29a, and 29d. In another exemplary embodiment, which is not depicted, each pole of each pair of poles 22, 24 can be curved to converge at the ends of the poles. In yet another exemplary embodiment, the poles are configured to not converge and each of the poles of side members 14, 16 is substantially straight when litter 10 is extended.

Another feature of the subject matter disclosed herein comprises a “split-beam” arrangement of a pair of poles 22, 24 as side members 14, 16 for frame assembly 12. That is, a top and bottom beam or pole 25, 27 is used for side members 14, 16 rather than a conventional single pole so that a patient is not resting on the ground when litter 10 is in its extended configuration. Thus, the split-beam avoids a need for support legs. Additionally, a pair of beams 22, 24 enhances the overall strength and rigidity of litter 10. Moreover, the overall weight of frame assembly 12 can be decreased without sacrificing strength even if traditional construction materials, such as metal alloys, are used.

In one exemplary embodiment, frame assembly 12 (FIG. 3A) comprises two modified box truss side beams and a minimum of two “bow-tie shaped” spreader members 20 (also referred to herein as lockable spreader assemblies) coupled between first and second modified box truss side members 14, 16. Each lockable spreader member 20 is comprised of two main triangular shaped (modified scalene or right-angle) sub-assemblies (left side comprising parts 70, 71, 73) (right side comprising parts 71, 72, 73) with vertex ends joined by a locking spreader sub-assembly. Both triangular-shaped spreader sub-assemblies are mirrored about the longitudinal axis of the litter assembly. The base ends (opposite from the vertex end) of the first and second triangular members are respectively coupled to a side member 14, 16 at hinge blocks 73 that are distal to coupling member 74. Accordingly, the convergent ends (vertex ends) 71 of first and second pairs of cross bars 70, 72 are proximate to lockable spreader member 20, and the divergent ends (base ends) 73 of first and second pairs of cross bars 70, 72 is distal to coupling member 74. In an alternative exemplary embodiment, frame assembly 12 comprises at least one spreader member 20 comprising the truss configuration disclosed herein. Moreover, it should be understood that a number of different dimensions and features are contemplated for spreader member 20.

In an unfolded configuration, cross bars 70, 72 are arranged in a vertical, or upright, position with respect to each other and extend perpendicular to side members 14, 16. That is, one cross tube from each pair of cross tubes is positioned on top of or over the second corresponding cross tube of the pair. The top cross tube of each pair of cross tubes 70, 72 is hingedly connected to the top 73 of hinge block 62 of each side member 14, 16. Similarly, the bottom cross tube of each pair of cross tubes 70, 72 is hingedly connected to the bottom 64 of hinge block 62 of each side member 14, 16.

The converging arrangement of the first and second pair of cross tubes 70, 72 of spreader member 20, which will be generally referred to herein as forming a triangular truss configuration (or triangularly shaped truss), provides enhanced structural aspects for the subject matter disclosed herein. In particular, the triangular shaped truss configuration increases the structural Moment of Inertia of the spreader member and counteracts the tension forces applied to the top side member tubes by the fabric bed. In other words, the triangular shaped spreader member accepts greater rotational moments at each end prior to bending and reduces the tendency for the tops of side members 14, 16 from rotating towards each other in response to a tension force that is applied to the respective tops of side members 14, 16 when the fabric bed 18 is tensioned between the tops of side members 14, 16. Moreover, such a tension force is exacerbated when a patient is placed on fabric bed 18. Further, the truss configuration depicted in FIG. 3A provides stability for the respective bottoms of side members 14, 16 when litter 10 is placed on a surface, such as the ground. If, for example, a spreader member that does not provide a truss configuration, such as a conventional cross bar arrangement depicted in FIG. 3B, is positioned between side members 14, 16, the point at which the cross bar couples to the side members 14, 16 will define the point about which side members 14, 16 will rotate. Existing collapsible litter systems within the same overall weight class with conventional single cross bar spreaders (reference FIG. 3B) will hold significantly less weight prior to the spreader member failing as compared to the triangular truss shaped spreader as depicted in FIGS. 1, 3A and 4-8.

FIG. 3B illustratively depicts a conventional spreader member 300′ that is not configured in a truss configuration in contrast to the general truss configuration of spreader member 20 depicted in FIG. 3A. In particular, spreader member 300′ comprises a first cross bar 301′ coupled to a second cross bar 302′ through a hinged-coupling mechanism 303′. Cross bars 301′, 302′ extend transversely in relation to the side members and are connected at about the center of opposing cross beams 62 that, in turn, are coupled to first and second pair of poles 22, 24 (FIG. 3A). If, for example, a fabric bed is tensioned between the tops of the side members, forces depicted by arrows 304′ are applied to the respective tops of the side members, thereby causing the respective tops of the side members to have a tendency to move in the directions of arrows 304′. This movement creates relatively large rotational moment forces around the connection point of spreader members 301′ and 302′ to side beam spacer members 62. The rotational moment forces are then counteracted by the relatively low-strength (small Moment of Inertia) conventional single-bar spreader member 300′. If, for example, spreader member 300′ is repositioned upwardly along cross beams 62 towards the tops of the side members to counteract the fabric bed tension forces and rotational moment forces, spreader member 300′ will interfere with a patient on the bed. Also, the weight of the patient will apply a lateral load to the single bar spreader exacerbating the loading conditions of the spreader. Additionally, the bottoms of the side members will have a correspondingly reduced stability. If, for example, conventional spreader member 300′ is positioned downwardly along the side beam spacers 62 towards the bottoms of the side members to improve stability of the bottoms of the side members, the tops of the side members will generally have more of a tendency to move inward in the directions of arrows 304′ so that the rotational moment forces are significantly higher and then counteracted by the relatively low-strength (small Moment of Inertia) single bar spreader member 300′. Thus, the truss configuration of spreader member 20, depicted in FIG. 3A, prevents both the tops and bottoms of the side members from having the tendency to move towards each other, accepts greater tension forces of the fabric bed, and has a significantly greater strength to weight ratio than a conventional single-bar spreader. Moreover, the truss configuration of spreader member 20 allows for the bed to stretch when a patient is on the bed without interfering with the patient.

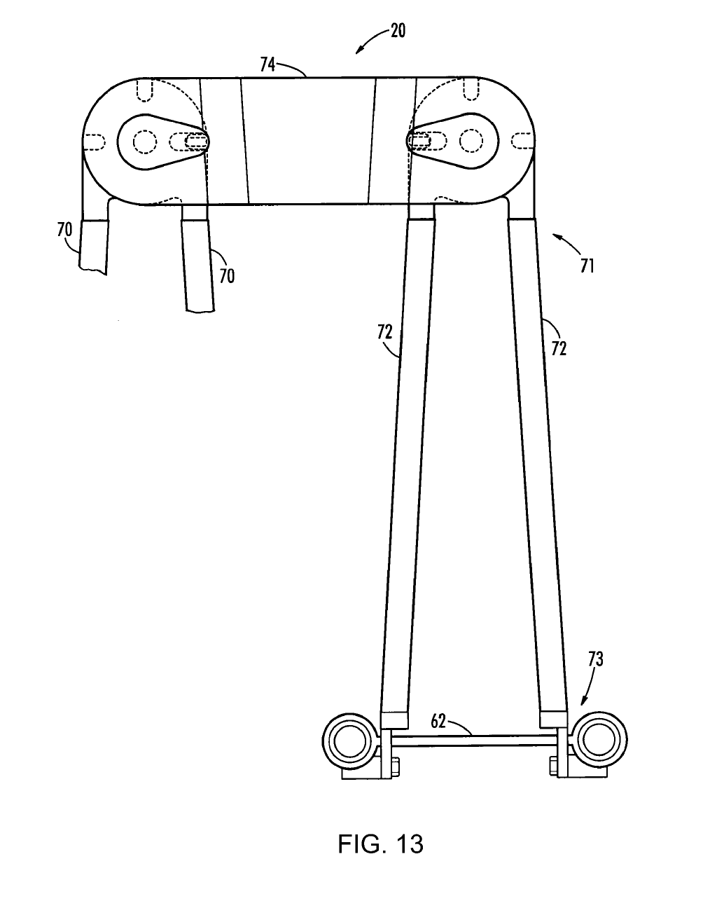

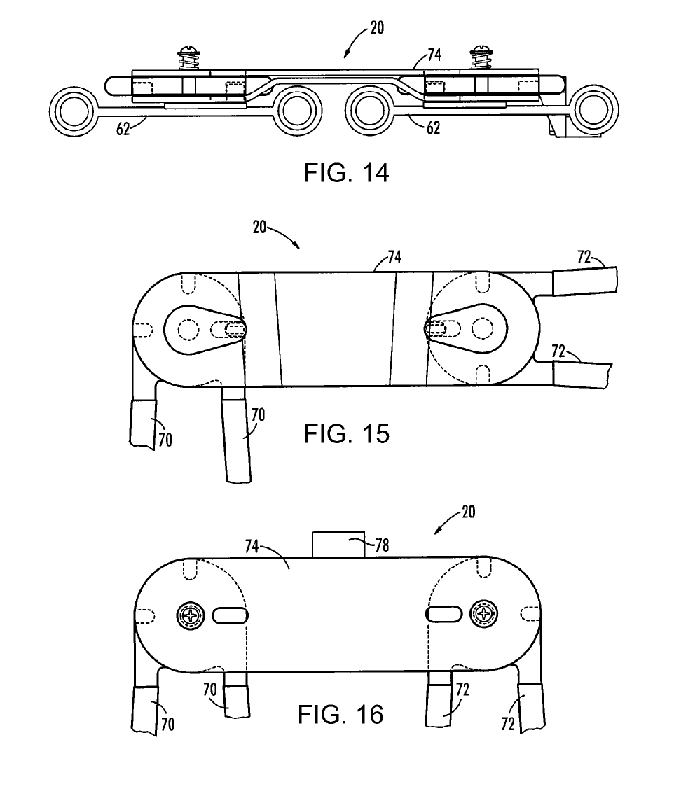

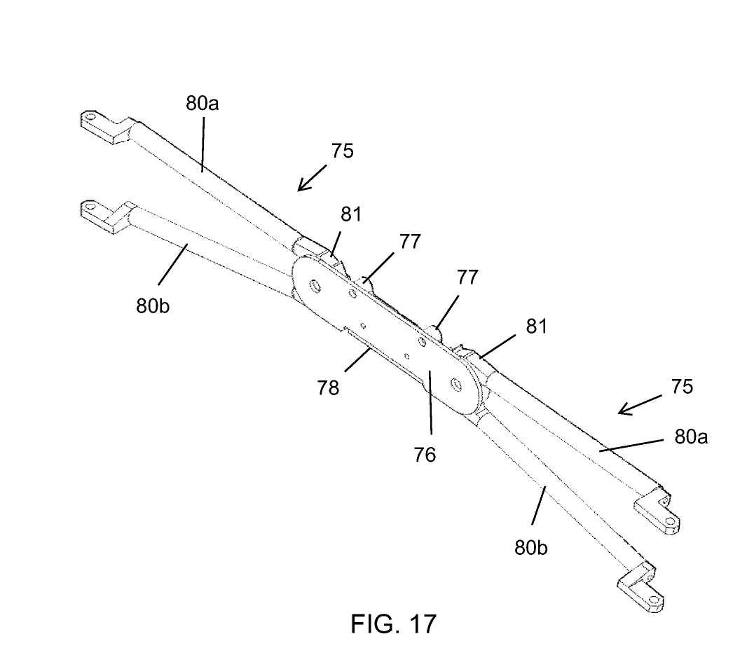

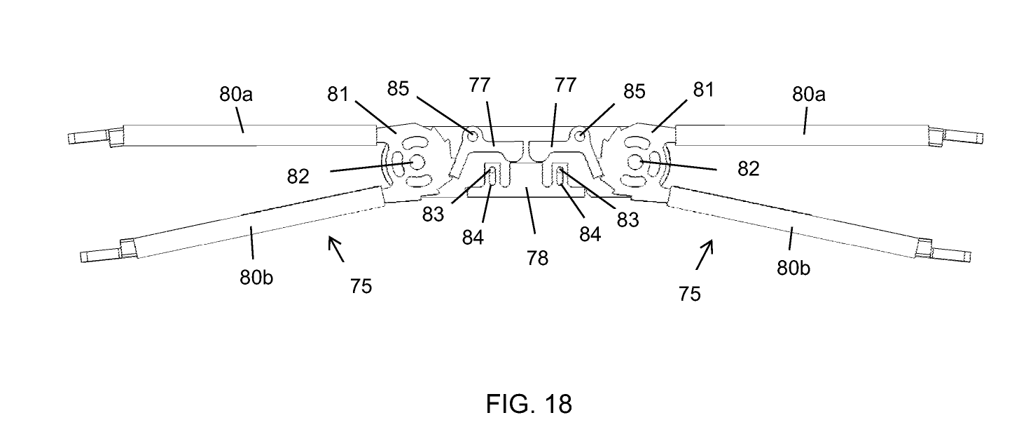

Additionally, in one exemplary embodiment, lockable spreader assembly 20 is lockable in one or more positions based on the need for space between the side members 14, 16. Variable spacing between side members 14, 16 may be required to tension fabric bed assembly 18 in FIGS. 1A, 1B, 2A and 2B based on manufacturing tolerances and thermal expansion/contraction. In one exemplary embodiment, lockable spreader assembly 20 is only unlocked by purposeful release, such as through a blade lock device, as depicted in FIGS. 13-16. Although numerous alternative locking techniques for lockable spreader assembly 20 are contemplated for use with the subject matter disclosed herein, one exemplary embodiment can comprise a ratcheting mechanism that is generally depicted in FIGS. 17 and 18. In particular, FIG. 17 shows a top perspective view of one exemplary embodiment of a lockable spreader assembly 20, and FIG. 18 shows a front view of the exemplary embodiment of lockable spreader assembly 20 with a cover plate 76 removed. The exemplary embodiment of lockable spreader assembly 20, as depicted in FIGS. 17 and 18, comprises a pair of lockable spreader subassemblies 75 that can be rotatably lockable at a plurality of increments, such as evenly spaced increments. Each lockable spreader subassembly 75 comprises arm members 80a and 80b (parts 70, 72 in FIG. 13) and a toothed ratchet member 81 (FIG. 18) that is coupled to an axle member 82 (FIG. 18). To unlock and rotate the lockable spreader subassemblies 75, a release bar 78 (also indicated in FIG. 16) is be activated, such as by pressing down. Release bar 78 moves along pins 83 as constrained by slots 84, which in turn causes lock links 77 (FIG. 18) to rotate around pin members 85, thereby disengaging with lockable spreader subassemblies (part 71 FIG. 13), and thereby releasing lockable spreader subassemblies 75 (FIG. 13) from a locked position until release bar 78 is released and lockable spreader subassemblies 75 are locked into place at a different increment.

A foldable handle 40 is included at each end of side members 14, 16. Handles 40 are pivotally connected to frame assembly 12 between each pair of poles 22, 24 of side members 14, 16. Generally, each handle 40 can be fully rotatable about a vertical axis that is substantially orthogonal to the longitudinal axis of side members 14, 16 when litter 10 is in an unfolded position. In addition to being rotatable, handles 40 are lockable and, optionally, handles 40 are lockable in a plurality of positions based on the particular need of the handles.

In one exemplary embodiment, a wheel 13 (FIG. 1B) is mounted on each of two handles 115 at the same end of medical litter 100. Each handle 115 locked in a rotational position in the direction that is parallel to the transverse axis 103 when medical litter 100 is in the unfolded and extended position. Other exemplary embodiments may include brackets 15 or axles (not shown) that are integrally machined or attached to the side rails, or machined surfaces or holes in the side rail hinge blocks, that are used for the mounting of wheels.

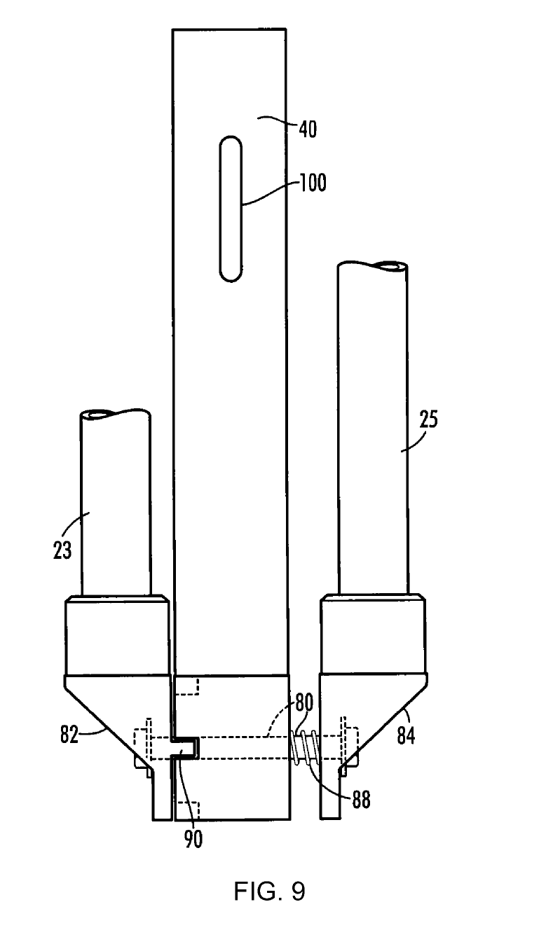

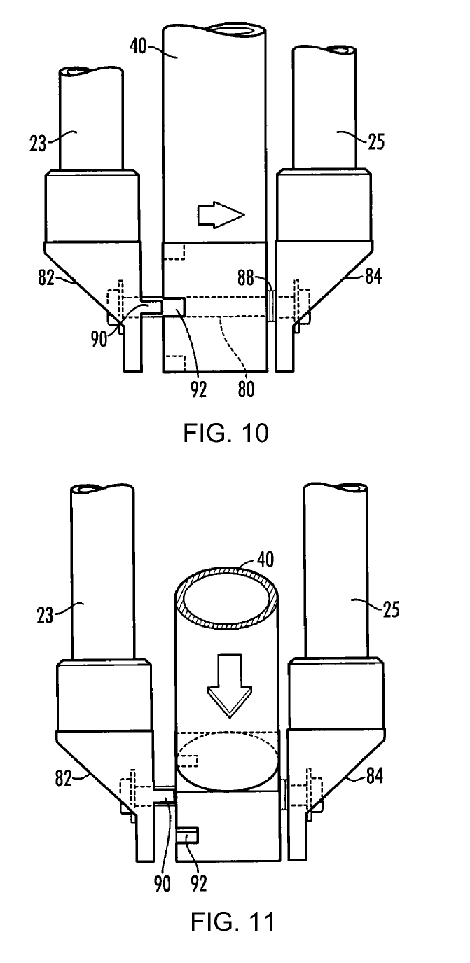

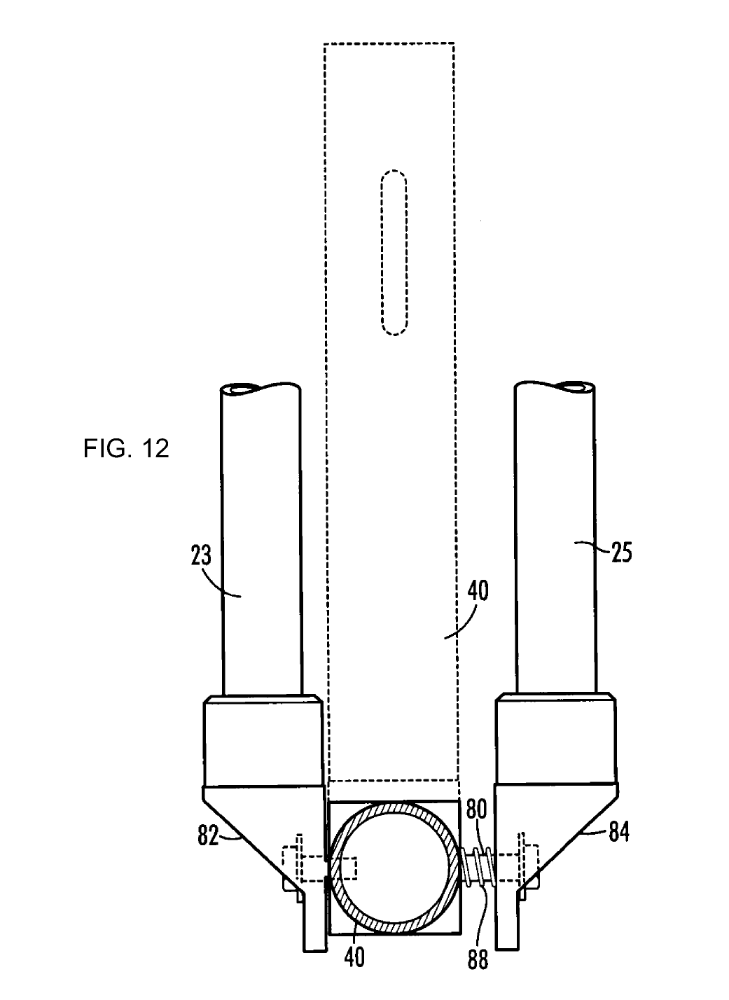

Although numerous alternative locking devices for handle 40 are contemplated for use with the subject matter disclosed herein, one exemplary embodiment is generally depicted in FIGS. 9-12. In this exemplary embodiment, handle 40 is pivotally connected to an axle 80 that is respectively connected to top and bottom poles 23, 25 through a first and second coupling members 82, 84. A spring 88 positioned around axle 80 forces handle 40 in the direction of a detent 90, which is connected to first coupling member 82 of top pole 23. Detent 90 corresponds to a plurality of notches 92 formed either integral with handle 40 or in a coupling device connecting handle 40 to axle 80. In use, handle 40 remains in a locked position until a positive force is applied to spring 88 thereby compressing spring 88 sufficiently to release detent 90 from a notch 92. Handle 40 can then move and rotate freely around axle 80 until spring 88 is released and detent 90 engages another notch 92. In one exemplary embodiment, handle 40 can be rotatable at evenly spaced increments, including increments that are spaced apart at about 90 degree.

An alternative exemplary embodiment of handle 40, which comprises a slot, or aperture, 100, is also depicted in FIG. 9. Slot 100 can be used in various applications, such as during transport of a patient. For example, a strap or cord (not shown) could be threaded through slot 100, which can be included in each of the handles, to create an additional carrying or transporting device. Such a strap could be threaded through the slots 100 of two handles at the same end of a litter and worn by medical personnel, thereby freeing the hands of the medical personnel while transporting a patient. Accordingly, medical personal could then use their hands to open doors or, in a combat situation, carry a defense weapon.

As shown in FIGS. 1 and 2, bed portion 18 of litter system 10 comprises a central bed section 110 located between side members 14, 16 of frame assembly 12 and that extends in a longitudinal direction parallel to that of side members 14, 16 when litter 10 is unfolded. The central bed portion 110 comprises a plurality of laterally extending panels, or connecting members, 120 that are dimensioned to receive and wrap around the top, opposing frame poles 23 of each of the first and second side members 14, 16 when litter 10 is unfolded. Panels 120 can be releasably secured to frame assembly 12 by any suitable technique, including, but not limited to, hook and loop fasteners, grommets, cords, or an adhesive, or a combination thereof. In one exemplary embodiment shown in FIG. 2, each side panel 120 comprises a first and second attachment member 122, 124. Along first attachment member 122, for example, a series of hook members are included that correspond to a series of loop members located on second attachment member 124. In an alternative exemplary embodiment, each side panel 120 comprises first, second and third attachment members 122, 124 and 123, as depicted in FIG. 2B. A series of hook members are included on first and third attachment members 122, 123 on adjacent surfaces. Both sides of second attachment member 124 include hook members that correspond to the hook members on first and third attachment members 122, 123. In use, third attachment member 123 is folded around frame assembly 12 and second attachment member 124 is positioned onto third attachment member 123 so that the corresponding hook and loop members engage. First attachment member 122 is then applied to the exposed surface of second attachment member 124 so that the corresponding hook and loop members of attachment members 122 and 124 engage and so that the second attachment member is positioned between first and third attachment members 122, 123.

In an alternative exemplary embodiment, one or more straps 130 are coupled to the surface of bed portion 18 on which a patient, or casualty, rests. Straps 130 can ensure that a patient is secured to bed portion 18 during transport. Additionally, straps 130 could be used to further secure bed portion 18 to frame assembly 12.

In another alternative exemplary embodiment, bed portion 18 is removably secured to frame 12 so that a patient, or casualty, remains safely supported throughout being transported. Side panels 120 of bed 18 provide a gripping device that could be used by medical personnel to safely lift and remove the patient from frame assembly 12 and thereafter place the patient on another bed, such as a hospital bed or gurney, thereby reducing the risk to the patient associated with transfers between multiple surfaces and locations after an injury. Additionally, because bed 18 is removable, bed 18 could be cleaned or discarded if bed 18 is no longer suitable for use.

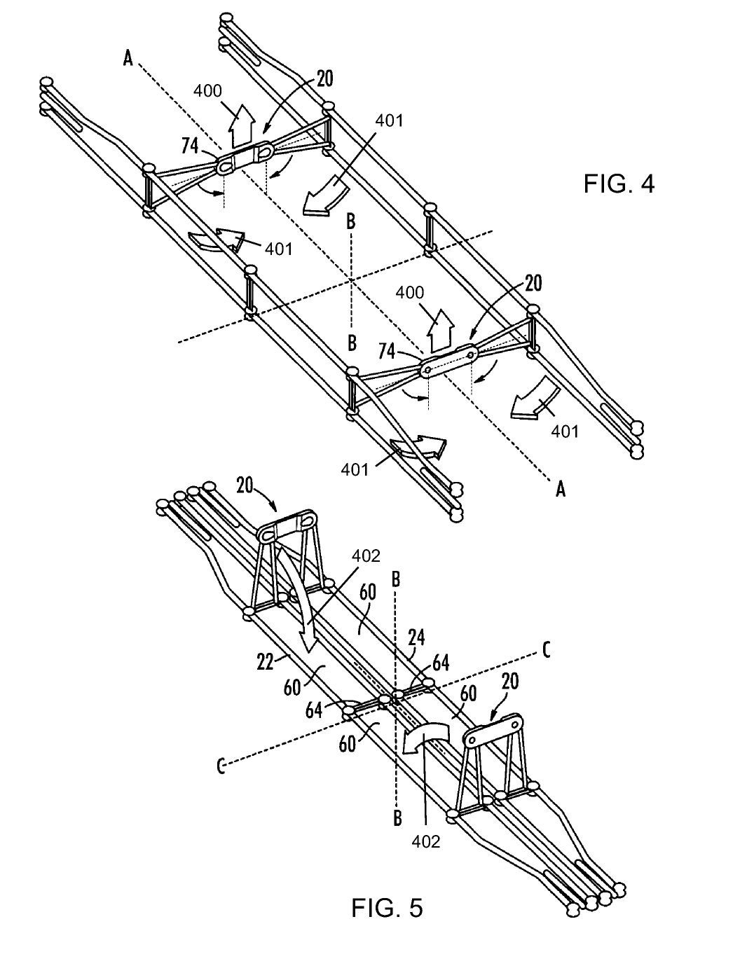

FIGS. 4-8 depict one exemplary technique for collapsing, or folding, litter system 10. For convenience and illustrative purposes, bed portion 18 of litter system 10 is removed so that the various pivoting motions and frame orientations are more clearly depicted and better understood. In a completely extended configuration (FIG. 4), collapse of litter 10 can begin by positively releasing the lock on any and all spreader members 20. Depending on the orientation of litter 10 (i.e., right side up or upside down), spreader member 20 can be moved up or down with respect to side members 14, 16. Frame assembly 12 can be flipped in orientation so that top poles 23 of the side members rest on the ground or a bottom support. In this orientation, once the lock of each spreader member 20 is released, the coupling plate 74 of each spreader member 20 is moved in a vertical direction (i.e., in the respective directions of arrows 400) parallel to a vertical axis B and generally perpendicularly to a longitudinal axis A, so that cross bars 70, 72 of a spreader member 20 can rotate about coupling plate 74 and longitudinal axis A to move beneath the plate 74 and towards each other (i.e., in the respective directions of arrows 401).

Simultaneous to the movement of cross bars 70, 72, side members 14, 16 are also rotated with respect to longitudinal axis A and moved beneath plate 74 as side members 14, 16 are coupled to cross bars 70, 72 (i.e., respective directions of arrows 401). That is, as depicted in FIG. 4, side members 14, 16 begin in a generally vertically oriented, upright position in separate planes that are generally parallel to a vertical axis B when litter 10 is extended. Thereafter, as depicted in FIG. 5, movement of a spreader 20 in a vertical direction causes side members 14, 16 to rotate about longitudinal axis A, and to end in a generally co-planar position, adjacent to each other, such that each spreader member 20 extends generally perpendicularly from the horizontal plane defined by side members 14, 16.

Once each spreader member 20 is in a fully upright position, as depicted in FIG. 5, each spreader member 20 is rotated (i.e., in the respective directions of arrows 402) about a transverse axis C towards the cavities 60 formed by parallel poles 22, 24 and cross beams 64. Cavities 60 are dimensioned to generally receive each spreader member 20 so that when received into a cavity 60, a spreader member 20 is generally co-planar and generally flush with side members 14, 16. At any time while litter 10 is being collapsed, handles 40 can be respectively rotated into cavities 60 so that handles 40 are substantially co-planar and substantially flush with side members 14, 16.

When frame assembly 12 is folded so that it is completely flat (FIG. 6) with side members 14, 16 in an adjacent, generally co-planar relation, handles 40 and spreader members 20 are positioned generally within the cavities 60. At this point, an accordion-like folding operation can begin, as depicted in FIGS. 6-8. By folding frame assembly 12 into the flat configuration depicted in FIG. 6, hinges 200 located at juncture points 64 are aligned for pivoting purposes. When hinges 200 are in lateral alignment parallel to transverse axis C, the pole arms can be pivoted (i.e., in the respective directions of arrows 403-407) to draw them together to the folded configuration, resembling a compressed W shape, as depicted in FIGS. 7 and 8. The folded compact structure can thereafter be placed into a carrying device, such as a backpack, for convenient transport and/or storage.

It should be noted that each separate component forming the exemplary embodiments of litter 10 previously described are not specifically identified by a reference numeral. Most notably, the pole arms, handles, spreader member, cross bars, coupling plates and coupling members are hingedly linked. The particular features of hinges 200 are not, however, fully described, but are shown in the Figures. Any suitable hinge device is contemplated for use in connection with the various features and components of the litter system and apparatus 10. Similarly, although certain exemplary embodiments of locking mechanisms are shown and described, it should be understood that these are merely examples to illustrate a suitable construction for the subject matter disclosed herein. Many substitutions and alternative exemplary embodiments are contemplated.

Additionally, various materials can be used to construct frame assembly 12, as well as bed portion 18. For example, in one exemplary embodiment, one or more of the components forming frame assembly 12 could be made from an aluminum alloy, or other metal alloy, or combinations thereof. In another exemplary embodiment, one or more of the components forming frame assembly 12 could be made from a carbon fiber material, a plastic, or other suitable composite material, or combinations thereof. Bed portion 18 could made from any suitable, sturdy material, including woven, non-woven, or knitted fabric made of natural or synthetic materials.

It should also be understood that additional components are not shown. Such components include a fabric and/or foldable bed comprising reinforced staggered openings and handle tube sections that are of a different diameter on each end of the medical litter. The purpose of the staggered reinforced openings is so that if the medical litter is leaned against a wall the openings can be used as steps and the medical litter can be used as an improvised ladder. The purpose of the different diameter handles is so the handles of one litter can be inserted into the handles of a second litter and the improvised “medical litter ladder” can be doubled in length.

Although the foregoing disclosed subject matter has been described in some detail for purposes of clarity of understanding, it will be apparent that certain changes and modifications may be practiced that are within the scope of the appended claims. Accordingly, the present embodiments are to be considered as illustrative and not restrictive, and the subject matter disclosed herein is not to be limited to the details given herein, but may be modified within the scope and equivalents of the appended claims.

What is claimed is:

1. An apparatus, comprising:
a frame assembly comprising a first side member and a second side member; and
at least one spreader member comprising a first triangular member, a coupling member and a second triangular member, the first and second triangular members each comprising a vertex end and a base end, the coupling member comprising first and second end portions, the first triangle member being coupled to the first side member along the base end of the first triangular member, the second triangle member being coupled to the second side member along the base end of the second triangular member, and the vertex end of the first triangular member and the vertex end of the second triangular member being respectively coupled to the first and second end portions of the coupling member.

2. The apparatus according to claim 1, wherein the first side member comprises a first pair of longitudinally extending poles, and a first plurality of cross beams connected between the first pair of longitudinally extending poles, the first plurality of cross beams and the first pair of longitudinally extending poles defining a first plurality of cavities, and
wherein the second side member comprises a second pair of longitudinally extending poles, and a second plurality of cross beams connected between the second pair of longitudinally extending poles, the second plurality of cross beams and the second pair of longitudinally extending poles defining a second plurality of cavities,
the apparatus further comprising at least one rotatable handle pivotally connected to an end of first side member or an end of the second side member.

3. The apparatus according to claim 2, wherein the first pair of longitudinally extending poles and the second pair of longitudinally extending poles each comprise a top pole and a bottom pole.

4. The apparatus according to claim 3, further comprising a bed releasably connected to the first side member and the second side member.

5. The apparatus according to claim 2, further comprising four rotatable handles, a handle being pivotally connected to an end of the first side member and to an end of the second side member.

6. The apparatus according to claim 5, wherein the four handles are each lockable in a plurality of directions.

7. The apparatus according to claim 4, further comprising two wheels, and
wherein one of the handles is an axle member for a corresponding wheel.

8. The apparatus according to claim 2, wherein the first and second pairs of longitudinally extending poles each comprise a top pole comprising a plurality of top pole arms that are pivotally connected, and
wherein the first and second pairs of longitudinally extending poles each comprises a bottom pole comprising a plurality of bottom pole arms that are pivotally connected.

9. The apparatus according to claim 1, wherein at least one spreader member is lockable in one of a plurality of positions between the first side member and the second side member.

10. The apparatus according to claim 1, further comprising two spreader members, each spreader member comprising a first triangular member, a coupling member and a second triangular member, the first and second triangular members each comprising a vertex end and a base end, the coupling member comprising first and second end portions, the first triangle member being coupled to the first side member along the base end of the first triangular member, the second triangle member being coupled to the second side member along the base end of the second triangular member, the vertex end of the first triangular member and the vertex end of the second triangular member being respectively coupled to the first and second end portions of the coupling member.

11. A system, comprising:
a frame assembly comprising a first side member and a second side member;
at least one spreader member comprising a first triangular member, a coupling member and a second triangular member, the first and second triangular members each comprising a vertex end and a base end, the coupling member comprising first and second end portions, the first triangle member being coupled to the first side member along the base end of the first triangular member, the second triangle member being coupled to the second side member along the base end of the second triangular member, and the vertex end of the first triangular member and the vertex end of the second triangular member being respectively coupled to the first and second end portions of the coupling member; and
a bed releasably connected to the frame assembly.

12. The system according to claim 11, wherein the first side member comprises a first pair of longitudinally extending poles, and a first plurality of cross beams connected between the first pair of longitudinally extending poles, the first plurality of cross beams and the first pair of longitudinally extending poles defining a first plurality of cavities, and
wherein the second side member comprises a second pair of longitudinally extending poles, and a second plurality of cross beams connected between the second pair of longitudinally extending poles, the second plurality of cross beams and the second pair of longitudinally extending poles defining a second plurality of cavities,
the system further comprising at least one rotatable handle pivotally connected to an end of first side member or an end of the second side member.

13. The system according to claim 12, wherein the first pair of longitudinally extending poles and the second pair of longitudinally extending poles each comprise a top pole and a bottom pole.

14. The system according to claim 13, further comprising a bed releasably connected to the first side member and the second side member.

15. The system according to claim 12, further comprising four rotatable handles, a handle being pivotally connected to an end of the first side member and to an end of the second side member.

16. The system according to claim 15, wherein the four handles are each lockable in a plurality of directions.

17. The system according to claim 12, wherein the first and second pairs of longitudinally extending poles each comprise a top pole comprising a plurality of top pole arms that are pivotally connected, and
wherein the first and second pairs of longitudinally extending poles each comprises a bottom pole comprising a plurality of bottom pole arms that are pivotally connected.

18. The apparatus according to claim 11, wherein at least one spreader member is lockable in one of a plurality of positions between the first side member and the second side member.

19. The system according to claim 11, further comprising two spreader members, each spreader member comprising a first triangular member, a coupling member and a second triangular member, the first and second triangular members each comprising a vertex end and a base end, the coupling member comprising first and second end portions, the first triangle member being coupled to the first side member along the base end of the first triangular member, the second triangle member being coupled to the second side member along the base end of the second triangular member, and the vertex end of the first triangular member and the vertex end of the second triangular member being respectively coupled to the first and second end portions of the coupling member.

20. A method, comprising:
providing an unfolded litter system, the litter system comprising a frame assembly comprising a first side member and a second side member, the first side member comprising a first pair of longitudinally extending poles and a first plurality of cross beams connected between the first pair of longitudinally extending poles, the first plurality of cross beams and the first pair of longitudinally extending poles defining a first plurality of cavities, and the first pair of longitudinally extending poles comprising a top pole comprising a plurality of top pole arms that are pivotally connected by a plurality of top hinges, and a bottom pole comprising a plurality of bottom pole arms that are pivotally connected by a plurality of bottom hinges, the second side member comprising a second pair of longitudinally extending poles and a second plurality of cross beams connected between the second pair of longitudinally extending poles, the second plurality of cross beams and the second pair of longitudinally extending poles defining a second plurality of cavities, and the second pair of longitudinally extending poles comprising a top pole comprising a plurality of top pole arms that are pivotally connected by a plurality of top hinges, and a bottom pole comprising a plurality of bottom pole arms that are pivotally connected by a plurality of bottom hinges, at least one locking spreader member comprising a first triangular member, a coupling member and a second triangular member, the first and second triangular members each comprising a vertex end and a base end, the coupling member comprising first and second end portions, the base end of the first triangular member being coupled to the first side member, the base end of the second triangular member being coupled to the second side member, and the vertex end of the first triangular member and the vertex end of the second triangular member being respectively coupled to the first and second end portions of the coupling member; and a bed releasably connected to the frame assembly; and at least one rotatable handle pivotally connected to an end of first side member or an end of the second side member;
folding the unfolded litter system, comprising:
unlocking each locking spreader member;
moving each spreader member to an upright position, while simultaneously moving the first and second side members to a co-planar, adjacent position beneath the upright spreader member, the upright spreader positioned in a plane that is about perpendicular to plane defined by the adjacent first and second side members;
folding each spreader member into one of the first plurality of cavities and a corresponding one of the second plurality of cavities;
rotating each handle into others of the first plurality of cavities and corresponding cavities of the second plurality of cavities;
aligning the top and bottom hinges; and
folding the top and bottom pole arms in an accordion-like fashion so that the frame assembly is in a fully folded, compact configuration.
